(19) United States
(12) Patent Application Publication
(10) Pub. No.: US 2003/0227198 A1
(43) Pub. Date: Dec. 11, 2003

(54) Adjustable saddle slide assembly

(76) Inventor: Jesse M. Menayan, Raleigh, NC (US)

Correspondence Address: Daniel M. Cislo, Cislo & Thomas, 233 Wilshire Blvd, Suite 900, Santa Monica, CA, 90401-1211, US

(21) Appl. No.: 10/163,680

(22) Filed: Jun. 5, 2002

(51) Int. Cl. B62J 1/00

(52) U.S. Cl. 297/215.14

(57) ABSTRACT

An assembly that is placed between a bicycle saddle and a mast supporting the saddle that allows a rider to adjust the saddle position while the cyclist is riding the bicycle. The assembly has two main positions, a forward position and a back position. The forward position maximizes use of the rider's fast twitch muscle groups and is the optimal saddle position for short sprint races and up-hill climbs. The back position maximizes the rider's slow twitch muscle groups and is the optimal position for long endurance races. The assembly uses a quick release mechanism to lock and unlock the saddle in place and allow for adjustments to be made “on the fly”. In order to maintain a constant distance between the saddle and the pedal axis, or bottom bracket, the assembly raises the height of the saddle slightly when the saddle is slid forward.

### BACKGROUND OF THE INVENTION

The present invention relates generally to the field of competitive bicycle racing, and more specifically to a device that allows a bicycle seat to be adjusted to various positions while the cyclist is riding the bicycle.

The sport of competitive bicycle racing is popular around the world. Bicycle racers train for years so that they can compete in well known bicycle races such as the Tour de France and the Olympics. All competitive bicycle races have one thing in common. The difference between winning and losing is a matter of mere seconds or even fractions of a second. Riders condition themselves to their ultimate level of fitness in order to increase their sustainable speed, and thus decrease the amount of time that it takes them to complete a race. In order to optimize a well conditioned rider's ability, competition bicycles are “set up” prior to the race in a configuration that is most suitable for the type of race in which the cyclist is competing, i.e., short sprint, long distance or mountainous. Seat, or saddle, position is an important factor in the set up process prior to a race. Studies of competitive cycling have produced different set up procedures for different types of races. For example, in short distance time trial races and uphill mountain climbing, it has been found beneficial to have the saddle of the bicycle positioned such that the cyclist's body is pushed forward relative to the bottom bracket. The bottom bracket being the axis about which the pedals rotate. This allows the cyclist to make use of the larger and stronger muscle groups in the legs for quick sprints or hill climbs. Unfortunately, this same group of muscles cannot provide continued power over an extended period of time, as is required for centuries (100 mile) and long distance stage (multi-day) races. For long, endurance type races, it has been found that cyclist are most efficient when their bodies are in a position further back, approximately one inch, with respect to the bottom bracket. This small movement in the position of the rider allows the rider to make use of different muscle groups (slow twitch muscle fibers), which provide for sustained power and endurance.

The above two set up arrangements make optimum use of the muscle groups in the rider's legs, as long as the race is either a sprint/hill climb or a long distance flat course. However, in many cycling competitions the racecourse includes both mountainous climbs as well as long distance sections of flats. Traditional bicycle saddles can provide only one ideal geometric configuration, thus forcing the cyclist to endure the race with the one seat position that was established during set up.

What is needed is saddle assembly that does not restrict the rider to one particular set up, but allows the cyclist to change his saddle set up “on the fly”, while the cyclist is riding the bike, in response to varying racecourse conditions. Previous saddle adjustment devices do not employ the simple mechanics of the present invention and further are not optimized for competition bicycles.

U.S. Pat. No. 5,513,895 entitled, “Adjustable Bicycle Seat Assembly”, discloses a bicycle seat that can be slid backwards, up to eight inches, to a position that allows the rider's lumbar spine to assume a protective lordotic curvature. A rectangular housing is secured to the bike's seat post and a seat support that includes a detent plunger is attached to the bicycle seat. The seat support slides to different positions within the rectangular housing and adjustments are made via thrusts provided by the rider. The seat support locks in place when the detent plunger engages a depression in the box. Alternatively, the seat can be secured to an inner pole that slides within an outer pole, with the help of a spring that biases the seat and inner pole in a rearward position. A brake system near the seat post holds the inner pole in place. A lever on the handle bars can be used to release the brake and allow sliding (adjustment) of the seat position.

U.S. Pat. No. 4,772,069 entitled, “Longitudinally Adjustable Saddle Mounting for Cycle-type Apparatus”, describes an involved sliding apparatus that requires a customized seat and seat post, which allows forward and backward movement of the saddle on a level horizontal plane. A spring loaded detent plunger in the top portion of the apparatus is raised by a lever, which allows the saddle to slide to an new position. The saddle is then secured in its new position by releasing the lever and allowing the plunger to engage a recess in the lower portion of the apparatus.

U.S. Pat. No. 4,580,835 entitled, “Quick Adjusting Saddle Locator”, discloses a spring loaded height adjustment system that employs a quick-release mechanism. A spring is used to bias the saddle and support column in an upward position and the quick-release secures the column in a desired position. This system allows only the height of the seat to be adjusted while the cyclist is riding the bike. The system includes the use of two types of springs, an external torsion spring or a coil spring through which the support column passes.

U.S. Pat. No. 3,992,054 entitled, “Bicycle Saddle Support”, shows a clamping mechanism for a saddle which replaces the clamping mechanism that comes with the bicycle. The lower portion of the mechanism is a pillar that slides down the seat post of the bicycle's frame. An upper portion is connected to the lower portion by a large screw that provides for compression of two bars that are connect to the saddle. The screw can be tightened and loosened using a hexagonal (Allen) wrench. Upon loosening of the screw, the seat can be moved forward, backwards, and the inclination of the seat can be changed.

None of these above patents allow a cyclist to adjust his saddle position on the fly between two optimal racing positions. Further, none of the above patents provides an adjustment assembly that allows use of the saddle and saddle post that come with traditional bicycles. Still further, these prior adjustment systems do not maintain a constant distance between the saddle and the bottom bracket.

### SUMMARY OF THE INVENTION

A saddle adjustment assembly that can be used in a traditional bicycle. The assembly is placed between the saddle and the saddle mast and allows the rider to adjust the position of the saddle while the rider is riding the bicycle. The assembly comprises a main slide, a clamp plate, and a quick release mechanism. The main slide comprises a lower portion that is adapted to be captured by the existing clamp on top of the bicycle's mast, and an upper portion that aids in capturing rails that run underneath the saddle. The clamp plate is placed on top of the rails and together with the upper portion of the main slide act as a clamp for holding the saddle in place. The quick release mechanism is housed within the main slide and includes a shaft that is connected to the clamp plate. A quick release cam lever extends outside of the main slide and can be moved between a locked position and an unlocked position by a hand of the rider. When the cam lever is in the locked position the saddle is securely in place and cannot be moved. When the cam lever is in the unlocked position the saddle can be slid within the saddle slide assembly to a new position.

When the assembly is in place the rider can adjust his saddle position while he/she is riding. The rider need merely flip the quick release cam lever down, slide the saddle forward or backwards, and then lift the quick release cam lever back up to its original position to lock the saddle in place. The present adjustable saddle slide assembly also advantageously raises the height of the saddle when the saddle is slid forward, and lowers the saddle when the saddle is slid backwards. This ensures the same distance is maintained between the saddle and the center of the bottom bracket, no matter which position is selected by the rider.

### BRIEF DESCRIPTION OF THE DRAWINGS

The invention of the present application will now be described in more detail with reference to the accompanying drawings, of the preferred embodiment given only by way of example, in which:

FIG. 1 shows the preferred embodiment in its operational position;

FIG. 2 shows a saddle locked in the back position be the preferred embodiment;

FIG. 3 shows the preferred embodiment with a saddle half way between the forward and back positions;

FIG. 4(a) shows a saddle locked in the back position;

FIG. 4(b) shows the preferred embodiment in the unlocked position;

FIG. 4(c) shows the saddle being slid to the forward position;

FIG. 4(d) shows the saddle being locked in the forward position;

FIG. 5 is a frontal view of the preferred embodiment;

FIG. 6 is a flow chart listing the steps for attaching the present assembly to a traditional bicycle; and,

FIG. 7 is a flow chart listing the steps for adjusting a saddle with the use of the present invention.

### DETAILED DESCRIPTION OF THE INVENTION

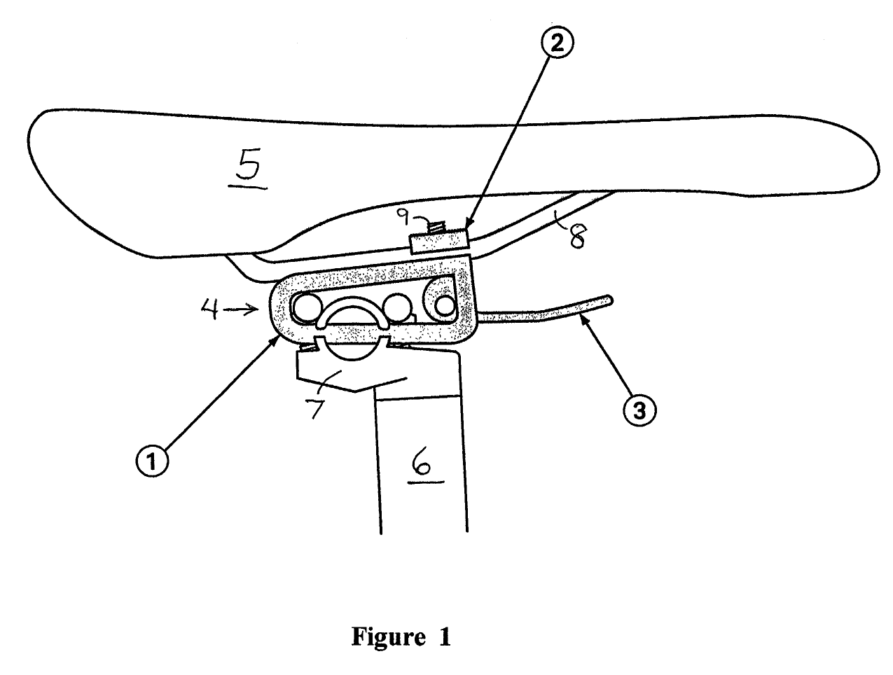

Referring to FIG. 1, a side view of the preferred embodiment is shown in its operational position. The adjustable saddle slide assembly 4 generally comprises three parts: main slide 1, clamp plate 2, and quick release cam lever 3. Adjustable saddle slide assembly 4 is placed between saddle 5 and mast 6 in order to give the rider the ability to adjust his saddle (seat) position while the cyclist is riding the bike, i.e., “on the fly”. Saddle 5 can be the existing seat on a traditional bicycle with rails 8 that run underneath the saddle and are used for clamping the saddle 5 in place. Typically there are two rails that extend below a traditional bicycle seat with both rails being used to secure the saddle in place. Since FIG. 1 is a side view, only one rail is visible. In operation, both rails 8 are releasably clamped in place between an upper portion of main slide 1 and clamp plate 2. Clamp plate 2 is connected to a quick release mechanism within slide assembly 4 via shaft 9. The quick release mechanism is well known in the art, commonly being used to quickly attach and release the front wheel of a bicycle from the frame of the bicycle. Therefore details concerning the construction of the quick release mechanism are not required.

The lower portion of main slide 1 is preferably constructed of two identical rails that are similar in size to the two rails 8 on the underside of saddle 5. Such a construction allows use of the existing clamp 7 that is found on the top of the mast 6 of traditional bicycles. Mast 6 is typically a pole or tube that slides inside the seat post portion of the bicycle's frame. Mast 6 is traditionally secured in place by a compression collar found at the top of the seat post (not shown). Clamp plate 2 and the upper portion of main slide 1 act in a similar manner as existing clamp 7 in that they “sandwich” the saddle's rails 8 in between the clamp plate 2 and main slide 4 and are used to releasably secure the saddle 5 in place. This design allows the present invention to be used in traditional bicycles without the need of customization or additional hardware.

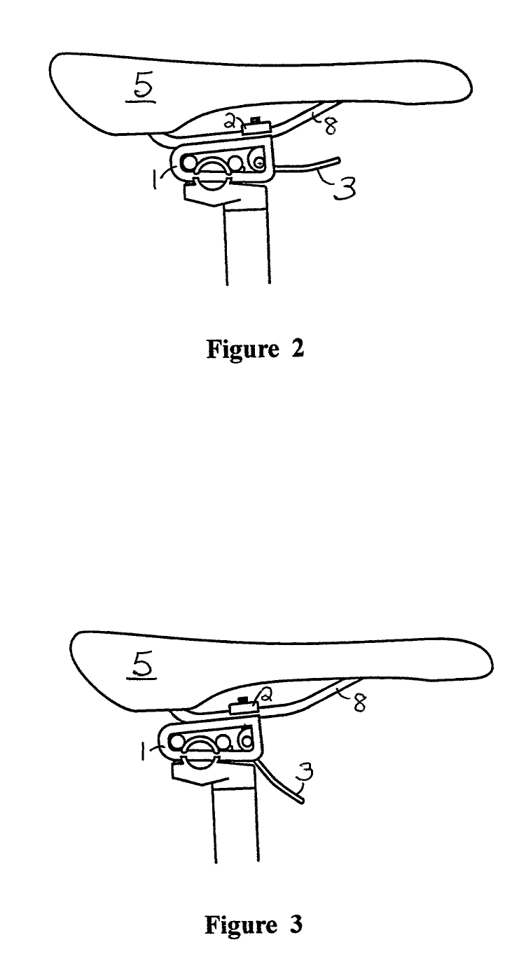

FIG. 2 shows the preferred embodiment in a locked position, meaning that the saddle 5 is secured and cannot be moved. In FIG. 2, the saddle 5 is in the back position; the position that has been found to be optimal for long distance endurance racing. Quick release cam lever 3 is in the up, or locked, position, thereby securing rail 8 between the upper portion of main slide 1 and clamp plate 2. Target customers for the present invention are competitive bicycle racers, whom are intensely interested in keeping their bicycles as lightweight as possible. As a counter measure for the weight added by the present invention, a lower portion of the bicycle's mast, substantially equal in weight to the slide assembly, could be removed from the mast and discarded. Thus, the present saddle slide assembly could be added to a bicycle without adding any net weight to the bicycle. Further, since the saddle slide assembly raises the height of the saddle, the lower discarded portion of the mast will not be missed, as the saddle will still be able to reach substantially the same height it would have if the lower mast portion were not removed. The overall result being that the rider is provided the advantage of being able to switch saddle positions on the fly, without adding substantial weight to his bicycle.

FIG. 3 shows the preferred embodiment in the unlocked position, meaning that the saddle 5 can be slid to a new position. In operation, the rider would only leave the present slide assembly in the unlocked position for one or two seconds; just long enough to slide the saddle 5 to the desired position. He/She would then immediately return the assembly to its locked position, thereby securing the saddle 5 in place and continue on with his race. FIG. 3 shows one step in the process of moving the saddle 5 from the back position to the forward position. Quick release cam lever 3 is in the down, or unlocked, position, thereby increasing the distance between clamp plate 2 and the upper portion of main slide 4. This allows rails 8 to slide in between the clamp plate 2 and the main slide 1. It should be noted that the slide assembly 4 provides a slight incline that slightly raises the height of saddle 5 as the saddle 5 is slid from the back position to the forward position. In the preferred embodiment, the saddle 5 automatically rises approximately ¼″ when the saddle is moved to the forward position. Since the rider is moving closer to the pedals as the saddle is moved forward, this rise in saddle height is needed to maintain a constant distance between the saddle and the bottom bracket (the axis about which the pedals rotate). It should be understood that the saddle automatically drops in height the same distance when the saddle is slid from the forward position to the back position. Again, this ensures the same distance between the rider and the pedals is maintained no matter what position the saddle is placed.

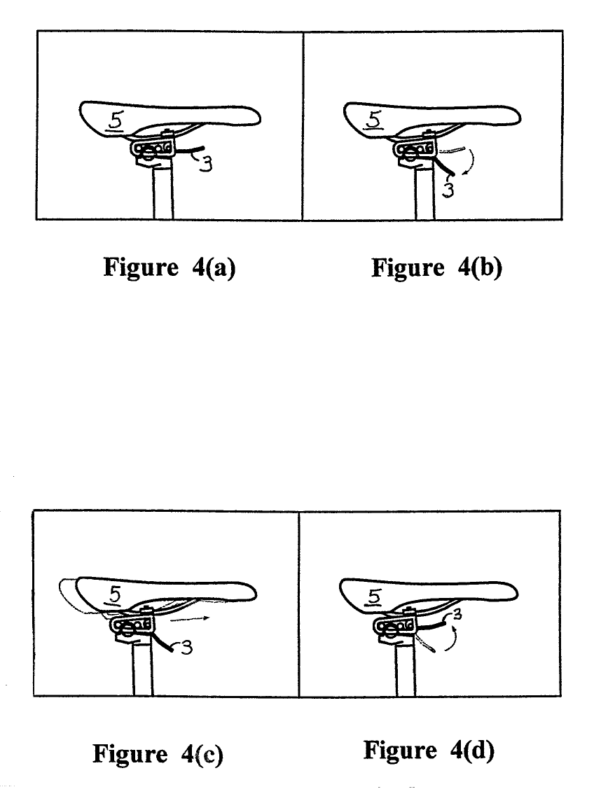

FIGS. 4(a) through 4(d) illustrate the process involved in moving the saddle 5 from the back position to the forward position. A rider would implement this process when he/she transfers from the portion of a racecourse that is flat to a portion that includes hill climbs, for example. In FIG. 4(a) the saddle is locked in the back position. In FIG. 4(b) the quick release cam lever is pushed downward into the unlocked position, thereby allowing the saddle 5 to be slid within the assembly. In FIG. 4(c), while the cam lever 3 is in the unlocked position, the saddle 5 is slid forward, approximately 1″ in the preferred embodiment. While the saddle 5 is being slid forward, as discussed above, the saddle 5 is also being raised slightly. FIG. 4(d) shows the last step in adjusting the saddle from the back position to the forward position. While the saddle is in the forward position, the quick release cam lever 3 is pulled upward to the locked position. This secures the rails of the saddle in a fixed position within the assembly and also transports the rider to his optimal position for sprinting or climbing hills.

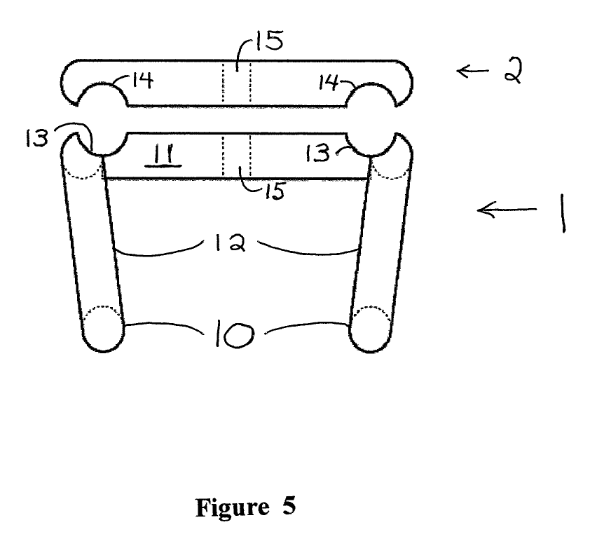

FIG. 5 is a frontal view of the main slide 1 and the clamp plate 2. The lower portion of main slide 1 is used to secure the present assembly to the mast of a bicycle. In the preferred embodiment, the lower portion comprises two rails 10 that can be secured within an existing clamp on top of a traditional mast. The two rails 10 are more clearly shown in FIGS. 1-3. The upper portion 11 of main slide 1 is designed to be complementary to the clamp plate 2. Grooves 13 are provided in the upper portion 11 and are aligned with grooves 14 on the clamp plate 2. Together, these two sets of grooves 13 and 14 are used to releasably secure the two rails of the saddle. The upper portion 11 and clamp plate 2 also have corresponding holes 15 that provide for passage of a shaft of the quick release mechanism. The quick release shaft is used to pull the clamp plate 2 downward to secure the saddle's rails in place, and also to release pressure on the rails thereby allowing the rails to slide within the assembly. Front vertical arms 12 connect the upper and lower portions of main slide 1 and are designed to be a specified height so as to provide a proper raising of the saddle as the saddle is adjusted to the forward position.

The present slide assembly is preferably designed to fit traditional bicycle seats and make use of the existing hardware on the bicycles. Alternatively, the existing clamp on top of the bicycle's mast does not have to be used, and the lower portion of the main slide can be permanently attached directly to the bicycle's mast. Of course, the upper portion of the main slide and the clamp plate can also be designed to accommodate saddles that have something other than two rails to secure the saddle in place, without departing from the main idea of the present invention.

The present slide assembly is preferably made of a lightweight metal such as aluminum. However, other materials, including alloys, plastics and composites, may also be used.

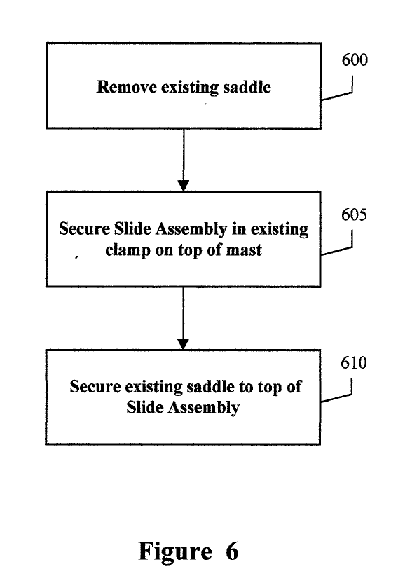

FIG. 6 illustrates the steps for attaching the present adjustable saddle slide assembly to a traditional bicycle. In step 600, the existing saddle of the bicycle is removed. This is typically accomplished by loosening a nut or bolt on a clamp that connects the saddle to the bicycle's mast until the seat can be removed. The saddle is then temporarily set aside. In step 605, the present slide assembly is placed in the clamp on top of the mast, where the saddle used to be, and the nut or bolt is tightened until the slide assembly is secure. The slide assembly is placed with the cam lever facing forward so that the lever is easily accessible to the rider. In step 610, the saddle that was removed and set aside is step 600 is secured to the top of the present slide assembly. In one embodiment, the shaft that connects the quick release mechanism to the clamp plate is a bolt that allows removal of the clamp plate. Once the clamp plate is removed, the underside of the saddle is placed on top of the main slide and the clamp plate is replaced. The shaft is then adjusted (turned) so that movement of the cam lever will alternatively secure the saddle in place or allow sliding of the saddle within the slide assembly.

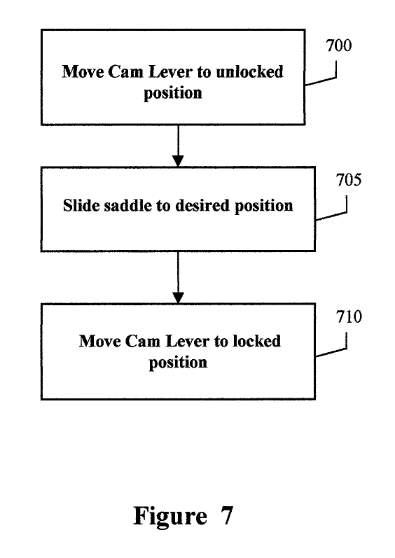

FIG. 7 illustrates the steps for adjusting the saddle from one position to another using the present slide assembly. In step 700, the rider uses one hand to move the cam lever downward to the unlocked position. In the unlocked position pressure on the rails underneath the saddle is released. In step 705, the rider uses the same hand to slide the saddle forward or backwards to the desired position. As discussed above, the saddle can be moved in response to a change in conditions of the course on which the cyclist is riding. The rider will move the seat backwards if he/she encounters long flat surfaces and he/she will move the saddle forward if he/she encounters hills or a sprinting section. In step 710, the rider then uses the same one hand to pull the cam lever up to the locked position, thus locking the saddle in the new position. The present slide assembly allows the rider to adjust his saddle position without having to stop and dismount the bicycle, which is particularly important to competitive cyclists.

The foregoing description of the specific embodiments will so fully reveal the general nature of the invention that others can, by applying current knowledge, readily modify and/or adapt for various applications such specific embodiments without departing from the generic concept. For example, small ridges could be provided on the upper portion of the main slide and on the clamp plate to aid in securing the saddle and to eliminate unwanted sliding during adjustments. Therefore, such adaptations and modifications should and are intended to be comprehended within the meaning and range of equivalents of the disclosed embodiments. It is to be understood that the phraseology of terminology employed herein is for the purpose of description and not of limitation.

I claim:

1. A bicycle saddle mast assembly which provides a quick means of adjusting a bicycle saddle forward and backward while the assembly automatically maintains a substantially constant distance between the saddle and a bottom bracket of a bicycle.

2. The saddle mast assembly of claim 1, wherein the assembly utilizes a quick release fixation lever to lock the saddle in different positions.

3. The saddle mast assembly of claim 1, wherein the saddle rises automatically as the saddle is adjusted to a forward position.

4. The saddle mast assembly of claim 1, wherein the saddle is lowered automatically as the saddle is adjusted to an aft position.

5. A bicycle saddle mount assembly comprising a main slide, a clamp plate, and a clamp release mechanism, that attaches to a bicycle saddle mast and provides a quick means of adjusting a saddle forward and backward while automatically maintaining a constant distance between the saddle and a bottom bracket of the bicycle.

6. The saddle mount assembly of claim 5, wherein the clamp release mechanism is a quick release mechanism comprising a fixation lever that is used to lock the saddle in different positions.

7. The saddle mount assembly of claim 5, wherein the saddle rises automatically as the saddle is adjusted to a forward position.

8. The saddle mount assembly of claim 5, wherein the saddle is lowered automatically as the saddle is adjusted to an aft position.

9. A saddle adjustment assembly for a bicycle that allows a rider to adjust a position of a saddle, substantially in a horizontal direction, while the rider is riding the bicycle, the assembly comprising:
a main slide that is attached to a mast of the bicycle;
a clamp plate that is used to secure the saddle to the main slide; and,
a quick release mechanism that is housed within the main slide and connected to the clamp plate, wherein a cam lever is used by the rider to release and lock the saddle in different positions.

10. The saddle adjustment assembly of claim 9, wherein the saddle remains a constant distance from a bottom bracket of the bicycle no matter what position the saddle is moved to.

11. The saddle adjustment assembly of claim 9, wherein the saddle can be adjusted to a forward position or a back position, and when the saddle is slid to the forward position the saddle is also raised to a height that is slightly higher than a height of the saddle in the back position.

12. The saddle adjustment assembly of claim 9, wherein the lower portion of the main slide is directly and permanently attached to the top of the mast.
